(19) United States
(12) Patent Application Publication
(10) Pub. No.: US 2020/0002643 A1
(43) Pub. Date: Jan. 2, 2020

(54) METHOD FOR TREATMENT OF CONTAMINATED SURFACES FROM OILFIELD WASTE

(71) Applicant: TERRA-HYDROCHEM, INC., Austin, TX (US)

(72) Inventor: Roger Kubala, Austin, TX (US)

(73) Assignee: TERRA-HYDROCHEM, INC., Austin, TX (US)

(21) Appl. No.: 16/453,158

(22) Filed: Jun. 26, 2019

Related U.S. Application Data
(60) Provisional application No. 62/691,817, filed on Jun. 29, 2018.

(51) Int. Cl. C11D 1/66; C11D 3/50; C11D 3/40; C11D 3/18; C11D 3/12; C11D 3/00; B09C 1/08

(52) U.S. Cl. CPC C11D 1/667; C11D 3/50; C11D 3/40; B08B 3/04; C11D 3/1213; C11D 3/0073; B09C 1/08; C11D 3/188

(57) ABSTRACT

The present invention pertains to a process for treating a contaminated surface. The composition employed may comprise an ester of a natural oil. If desired, then other components may be added. Such components include, but are not limited to, fragrances, colorants, additional reactants and the like.

### CROSS REFERENCE TO RELATED APPLICATIONS

This application claims priority to U.S. provisional application 62/691,817 which is incorporated herein by reference.

### FIELD OF THE INVENTION

The present invention relates to a method for treating contaminated surfaces including, for example, laboratory glassware and/or railcars and/or above or below ground storage tanks, barges, and/or other equipment that may have oilfield waste contaminating them.

### BACKGROUND AND SUMMARY OF THE INVENTION

Oil and gas drill operations, both onshore and offshore, as well as various laboratory experiments and the like generate surfaces in need of cleaning. Many such cleaning methods involve employing highly flammable and/or toxic materials like organic solvents such as toluene, xylene and the like. In many environments such as a laboratory, for example, such highly flammable and/or toxic materials may be an issue. Thus, what is needed is a method for treating surfaces such as laboratory glassware and the like that does not involve a highly flammable and/or toxic material yet effectively removes a majority to all of the contaminants. It would also be desirable if the method and/or product were environmentally friendly, safe for users involved in the cleaning and/or eliminated or decreased the need for confined space entry in the cleaning process.

Advantageously, the present invention often meets all the aforementioned needs and more. In one embodiment the invention pertains to a process for treating a contaminated surface. Surfaces may include those selected from laboratory glassware, pipelines, rail cars, frac tanks, mechanical equipment, environmental spills, soil, barges, and the like. The process typically comprises contacting said contaminated surface with a composition comprising an alkyl or aliphatic ester of a fatty acid under conditions to decontaminate said surface.

### DETAILED DESCRIPTION

In one embodiment the invention relates to a process for treating a contaminated surface. The type of contaminated surface is not particularly important so long as it is capable of being treated by the present invention. Typical contaminated surfaces that may be treated by the present invention include, for example, laboratory glassware, pipelines, rail cars, frac tanks, mechanical equipment, environmental spills, soil, barges, and the like.

Contaminants capable of being treated by the present invention include, but are not limited to, contaminants from oil and gas processing such as hydrocarbon residues, residues from oilfield assets, petroleum deposits including breaking down or even liquefying contaminates that may be baked-on or hardened such as asphaltenes, as well as contaminants on industrial machinery. Advantageously, the composition may be formulated at least in part or in some cases even entirely from plant-based constituents such as oil extracts. Thus, the composition may be relatively non-toxic and non-hazardous to both people, animals, as well as the the environment.

In yet another advantage, in many cases the composition may be applied undiluted as a pre-treatment soak. In some embodiments, employing the method an composition may reduce or even eliminate the need for steam cleaning, reduce labor time, simplify cleaning, replace multiple cleaning products, and/or reduce the need for personnel to enter confined spaces such as railcars and the like.

The specific composition and method to be employed may vary widely depending upon the application, the specific contaminants, the desired amount of cleaning, and other factors. Typically, for applications such as cleaning laboratory glassware, rail cars and the like the composition may comprise an ester of a natural oil. One representative such ester may include an alkyl or aliphatic ester of a fatty acid such as a lower alkyl such as a methyl or ethyl ester of a natural oil such as, for example, soy bean oil, fish oil, or combinations thereof. The ordinarily skilled artisan understands that such esters may include those lower alkyl (C1-C3 such as methyl, ethyl, or propyl) esters of palmitic, stearic, oleic, linoleic, linolenic, as well as other esters of such fatty acids and mixtures thereof.

If desired, then other components may be added. Such components include, but are not limited to, fragrances, colorants, additional reactants and the like. Such components may include hydrocarbons like mono-terpenes or the like. Such mono-terpenes include, for example, D or R limonenes. If desired, components such as a nano scale zinc oxide (nZnO2) may be added as desired to potentially increase effectiveness. Another useful component may include nano-scale iron chelate, e.g., (C₁₀H12FeN₂O₈). The added amounts may vary depending upon desired result, contaminants and other ingredients. However, in some embodiments the amount added, particularly for nano-scale iron chelate may be that amount effective to facilitate at least partial to almost complete decontamination of H₂S if present.

The ratio of ester of a natural oil to other ingredients may vary widely depending upon the specific reactants, conditions, contaminants and desired results for the given application. That is, any convenient formula may be employed so long as the surface is adequately cleaned using an appropriate method. Similarly, any convenient manner of contact and time may be employed.

For example, a composition comprising greater than about 90, or greater than about 92, or greater than about 94, or greater than about 96, or greater than about 98% by weight of a methyl ester of soy bean oil may be sprayed onto a contaminated laboratory glassware surface and then washed with, for example, water to clean the glassware. If desired a fragrance or additional component such as a limonene like D-liminene may be included with a methyl ester of soy bean oil at, for example, less than about 5, or 3 or 2% by weight based on the total composition. The composition may be sprayed or otherwise applied to a surface contaminated with, for example, heavy crude oils, oxidized crudes, maltenes, asphaltenes, and mixtures thereof under conditions which liquefy and/or isolate said contaminates thereby reducing or eliminating the contaminates which may be washed away using water or other suitable substance.

In another embodiment a nano scale compound of iron, magnesium, or both may be encapsulated. The nano scale compound of iron, magnesium, or both may be any that is capable of being encapsulated, i.e., surrounded, by one or more oil-liquid membranes. The nano scale compound is typically selected from the group consisting of chelated iron, chelated magnesium, iron/magnesium, zero valent magnesium, zero valent iron, or a mixture thereof. By nanoscale is meant particles wherein the mean diameter of the metal particles is at least about 50, or at least about 75, or at least about 100 nm up to about 600, or up to about 500, or up to about 400 nm. By “food grade plant oil-liquid membrane” is meant a substantially hydrophobic membrane comprised of biodegradable surfactant and biodegradable oil. In this manner, when water is employed with biodegradable surfactant, biodegradable oil, and the nanoscale compound, then an aqueous emulsion is formed.

The aforementioned aqueous emulsions may be prepared in any convenient manner. Typically, an emulsion is made by first acquiring or making a metal compound, i.e., emulsion precursor. For example, a chelated iron precursor is prepared by mixing nanoscale chelated iron, water, and a chelating agent and heating it to form a slurry. A chelated magnesium precursor may be made by mixing water, base such as sodium hydroxide, and nanoscale magnesium. An iron/magnesium precursor may be made by mixing nanoscale magnesium, hot iron, and one or more surfactants such as polysorbates and/or fatty acid esters such as sorbitan esters. Similarly, a zero valent magnesium precursor may be made by mixing water, a base such as sodium hydroxide, nanoscale zero valent nanoscale magnesium, and one or more surfactants such as polysorbates and/or fatty acid esters such as sorbitan esters while zero valent iron precursor may be made by mixing water, a mineral acid, nanoscale zero valent iron, one or more surfactants such as polysorbates and/or fatty acid esters such as sorbitan esters.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A process for treating a contaminated surface selected from laboratory glassware, pipelines, rail cars, frac tanks, mechanical equipment, environmental spills, soil, barges, and the like wherein said process comprises contacting said contaminated surface with a composition comprising an alkyl or aliphatic ester of a fatty acid.

2. The process of claim 1 wherein said surface comprises a surface selected from the group consisting of laboratory glassware, pipelines, rail cars, frac tanks, mechanical equipment, environmental spills, soil, and barges.

3. The process of claim 1 wherein the composition comprises a methyl or ethyl ester of a fatty acid.

4. The process of claim 1 wherein the composition comprises greater than about 90% of a methyl ester of soy bean oil.

5. The process of claim 1 wherein the composition comprises greater than about 94% of a methyl ester of soy bean oil.

6. The process of claim 1 wherein the composition comprises greater than about 98% of a methyl ester of soy bean oil.

7. The process of claim 1 wherein the composition further comprises a fragrance.

8. The process of claim 1 wherein the composition further comprises a limonene.

9. The process of claim 1 wherein the composition further comprises D-liminene.

10. The process of claim 1 wherein the composition further comprises D-liminene in an amount of from about 0.5 to about 2% by weight based on the total composition.

11. The process of claim 1 wherein the composition further comprises a colorant.

12. The process of claim 1 wherein the composition further comprises a mono-terpene.

13. The process of claim 1 wherein the composition further comprises R-limonene.

14. The process of claim 1 wherein the composition further comprises nano scale zinc oxide.

15. The process of claim 1 wherein the composition further comprises nano-scale iron chelate.

16. The process of claim 1 wherein the composition further comprises nano-scale iron chelate in an amount to facilitate at least partial decontamination of H₂S.

17. The process of claim 1 wherein the composition comprises a C1-C3 alkyl ester of an acid selected from palmitic, stearic, oleic, linoleic, linolenic, and combinations thereof.
